(19) United States
(12) Patent Application Publication
(10) Pub. No.: US 2015/0032648 A1
(43) Pub. Date: Jan. 29, 2015

(54) CUSTOMIZING INFORMATIONAL MODULES THAT ARE DISTRIBUTED HIERARCHICALLY

(71) Applicant: Healthcare Compliance Pros, Inc., Salt Lake City, UT (US)

(72) Inventor: Bryan Roberts, Farmington, UT (US)

(21) Appl. No.: 14/336,992

(22) Filed: Jul. 21, 2014

Related U.S. Application Data
(60) Provisional application No. 61/857,616, filed on Jul. 23, 2013.

(51) Int. Cl. G06Q 30/00; G06Q 10/10

(52) U.S. Cl. CPC G06Q 30/018; G06Q 10/105
USPC 705/317

(57) ABSTRACT

The present invention is directed to providing an online compliance training and monitoring system that allows informational modules to be distributed hierarchically within a client's organizational structure. As the informational modules are distributed hierarchically, the client can make customizations to the informational modules that will apply at specified levels of the client's organizational hierarchy. Customizations can be made at the client level which will apply to versions of the informational module distributed to each office under the client account. Similarly, customizations can be made at the office level which will apply to versions of the informational module distributed to users of the office that made the customizations. In this way, a customized informational module can be provided to each office within the client's hierarchy so that the office receives the training and informational material that is required by the rules and regulations that govern the office.

### RELATED APPLICATION

This application claims priority to U.S. Provisional Patent Application Ser. No. 61/857,616, filed Jul. 23, 2013 and titled CUSTOMIZING INFORMATIONAL MODULES THAT ARE DISTRIBUTED HIERARCHICALLY, which is incorporated herein in its entirety.

### BACKGROUND

Many industries require that their professionals and employees receive some level of certification, accreditation, or compliance. For example, the health care industry is governed by a substantial amount of federal and state regulation that requires ongoing education and training of its professionals and employees. Similarly, the legal profession is governed by continuing legal education rules that require legal professionals to obtain a specified number of continuing legal education credits on a periodic basis. Further, many industries are required to comply with the Occupational Safety and Health Act (OSHA) by providing training to workers in these industries.

It most cases, the employer is responsible for ensuring that its employees receive the required training or information to comply with the applicable rules or regulations. Due to the number of rules and regulations that may govern a particular industry or portion of an industry and the number of changes that are frequently being made to such rules and regulations, it can be difficult to track what training a particular employee must take and when the employee must take the training.

For example, an employer may have employees that work in different fields that are each governed by a different set of rules or regulations. As an example, a health care employer may have employees in one field that are governed by HIPAA and a first set of OSHA regulations and employees in another field that are governed by a second set of OSHA regulations.

### BRIEF SUMMARY

The present invention extends to methods, systems, and computer program products for providing an online compliance training and monitoring system that allows informational modules to be distributed hierarchically within a client's organizational structure. As the informational modules are distributed hierarchically, the client can make customizations to the informational modules that will apply at specified levels of the client's organizational hierarchy. Customizations can be made at the client level which will apply to versions of the informational module distributed to each office under the client account. Similarly, customizations can be made at the office level which will apply to versions of the informational module distributed to users of the office that made the customizations. In this way, a customized informational module can be provided to each office within the client's hierarchy so that the office receives the training and informational material that is required by the rules and regulations that govern the office.

The present invention can also provide the ability to customize an informational module for a particular grouping of users. Such customizations can apply to users within a single office or to users across offices of the client. The present invention can also provide user interfaces (e.g. in the form of a website) for facilitating the tracking of which users of an office have been assigned an informational module or have completed an informational module. The present invention can also provide user interfaces for assigning or un-assigning modules to individual users or to groups of users within the office.

In one embodiment, the present invention is implemented as a method for providing customizations to an informational module that is distributed hierarchically from a client account to one or more offices and to one or more users in the one or more offices. An informational module containing default content is generated. The default content corresponds to one or more rules or regulations governing an industry. The informational module is distributed to a client account of a first client. The client account has one or more offices arranged hierarchically below the client account. Each of the one or more offices has one or more users arranged hierarchically below the office. A customization to the default content of the informational module is received from the client account. The informational module is updated to include the default content and the customization to the default content. The informational module is distributed to each of the one or more offices arranged hierarchically below the client account such that the informational module with the customization to the default content is made available to at least one user in each of the one or more offices.

In another embodiment, the present invention is implemented as a method for providing customizations to an informational module that is distributed hierarchically from a client account to one or more offices and to one or more users in the one or more offices. An informational module containing content corresponding to one or more rules or regulations governing an industry is generated. The informational module is distributed to a client account of a first client. The client account has one or more offices arranged hierarchically below the client account. Each of the one or more offices has one or more users arranged hierarchically below the office. The informational module is distributed to a first office of the one or more offices. A customization to the content of the informational module is received from the first office. The informational module is updated to include the customization to the content. The informational module with the customization is then distributed to at least one user in the first office.

In another embodiment, the present invention is implemented as a method for facilitating the tracking of compliance with one or more rules or regulations governing an industry. An informational module containing content corresponding to one or more rules or regulations governing an industry is generated. The informational module is distributed to a client account of a first client. The client account has one or more offices arranged hierarchically below the client account. Each of the one or more offices has one or more users arranged hierarchically below the office. The informational module is distributed to a first office of the one or more offices. Input is received from the first office that assigns the informational module to a plurality of users in the first office. A first user interface is provided to each of the plurality of users by which the users can access the informational module to complete the informational module. It is then tracked which of the plurality of clients has completed the informational module. A second user interface is provided to the first office. The second interface comprises a listing of the plurality of users and includes an indication of whether each of the plurality of users has completed the informational module.

This summary is provided to introduce a selection of concepts in a simplified form that are further described below in the Detailed Description. This Summary is not intended to identify key features or essential features of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computing environment in which the present invention can be implemented;

FIG. 2 illustrates an example of a plurality of slides that make up an informational module;

FIG. 3 illustrates an example of a hierarchical structure that can be used by the present invention to distribute informational modules;

FIG. 4 illustrates an example of how a client can control the distribution of an informational module at the client account level;

FIG. 5 illustrates that each office under a client account can independently customize an informational module;

FIG. 6 illustrates a webpage that can be displayed to a manager at the client account level to allow the manager to customize an informational module at the client account level;

FIG. 7 illustrates a portion of a webpage that can be displayed when a manager at the client account level selects to customize an informational module;

FIG. 8 illustrates a webpage that can be displayed when a slide of an informational module is selected for customization;

FIG. 9 illustrates a preview of a slide;

FIG. 10 illustrates that custom content has been input to the webpage of FIG. 8;

FIG. 11 illustrate a preview of the slide that includes the custom content;

FIG. 12 illustrates a webpage that can be displayed to allow a new slide to be added;

FIG. 13 illustrates a preview of a new slide to be added to the informational module;

FIG. 14 illustrates a portion of the slides in an informational module including the newly added slide;

FIG. 15 illustrates the webpage of FIG. 8 when the selected slide requires content to be added;

FIG. 16 illustrates a webpage that lists employees of an office along with each informational module available to the office;

FIG. 17 illustrates a webpage for customizing which modules are assigned to a particular user and for inviting the user to complete the assigned modules; and

FIG. 18 illustrates a webpage that provides the ability to view employees that match various different types of criteria related to the assignment and completion of an informational module.

### DETAILED DESCRIPTION

The present invention extends to methods, systems, and computer program products for providing an online compliance training and monitoring system that allows informational modules to be distributed hierarchically within a client's organizational structure. As the informational modules are distributed hierarchically, the client can make customizations to the informational modules that will apply at specified levels of the client's organizational hierarchy. Customizations can be made at the client level which will apply to versions of the informational module distributed to each office under the client account. Similarly, customizations can be made at the office level which will apply to versions of the informational module distributed to users of the office that made the customizations. In this way, a customized informational module can be provided to each office within the client's hierarchy so that the office receives the training and informational material that is required by the rules and regulations that govern the office.

The present invention can also provide the ability to customize an informational module for a particular grouping of users. Such customizations can apply to users within a single office or to users across offices of the client. The present invention can also provide user interfaces (e.g. in the form of a website) for facilitating the tracking of which users of an office have been assigned an informational module or have completed an informational module. The present invention can also provide user interfaces for assigning or un-assigning modules to individual users or to groups of users within the office.

In one embodiment, the present invention is implemented as a method for providing customizations to an informational module that is distributed hierarchically from a client account to one or more offices and to one or more users in the one or more offices. An informational module containing default content is generated. The default content corresponds to one or more rules or regulations governing an industry. The informational module is distributed to a client account of a first client. The client account has one or more offices arranged hierarchically below the client account. Each of the one or more offices has one or more users arranged hierarchically below the office. A customization to the default content of the informational module is received from the client account. The informational module is updated to include the default content and the customization to the default content. The informational module is distributed to each of the one or more offices arranged hierarchically below the client account such that the informational module with the customization to the default content is made available to at least one user in each of the one or more offices.

In another embodiment, the present invention is implemented as a method for providing customizations to an informational module that is distributed hierarchically from a client account to one or more offices and to one or more users in the one or more offices. An informational module containing content corresponding to one or more rules or regulations governing an industry is generated. The informational module is distributed to a client account of a first client. The client account has one or more offices arranged hierarchically below the client account. Each of the one or more offices has one or more users arranged hierarchically below the office. The informational module is distributed to a first office of the one or more offices. A customization to the content of the informational module is received from the first office. The informational module is updated to include the customization to the content. The informational module with the customization is then distributed to at least one user in the first office.

In another embodiment, the present invention is implemented as a method for facilitating the tracking of compliance with one or more rules or regulations governing an industry. An informational module containing content corresponding to one or more rules or regulations governing an industry is generated. The informational module is distributed to a client account of a first client. The client account has one or more offices arranged hierarchically below the client account. Each of the one or more offices has one or more users arranged hierarchically below the office. The informational module is distributed to a first office of the one or more offices. Input is received from the first office that assigns the informational module to a plurality of users in the first office. A first user interface is provided to each of the plurality of users by which the users can access the informational module to complete the informational module. It is then tracked which of the plurality of clients has completed the informational module. A second user interface is provided to the first office. The second interface comprises a listing of the plurality of users and includes an indication of whether each of the plurality of users has completed the informational module.

Example Computer Architecture and Environment

Embodiments of the present invention may comprise or utilize special purpose or general-purpose computers including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system.

Computer-readable media is categorized into two disjoint categories: computer storage media and transmission media. Computer storage media (devices) include RAM, ROM, EEPROM, CD-ROM, solid state drives (“SSDs”) (e.g., based on RAM), flash memory, phase-change memory (“PCM”), other types of memory, other optical disk storage, magnetic disk storage or other magnetic storage devices, or any other similarly storage medium which can be used to store desired program code means in the form of computer-executable instructions or data structures and which can be accessed by a general purpose or special purpose computer. Transmission media include signals and carrier waves.

Computer-executable instructions comprise, for example, instructions and data which, when executed by a processor, cause a general purpose computer, special purpose computer, or special purpose processing device to perform a certain function or group of functions. The computer executable instructions may be, for example, binaries, intermediate format instructions such as assembly language or P-Code, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like.

The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices. An example of a distributed system environment is a cloud of networked servers or server resources. Accordingly, the present invention can be hosted in a cloud environment.

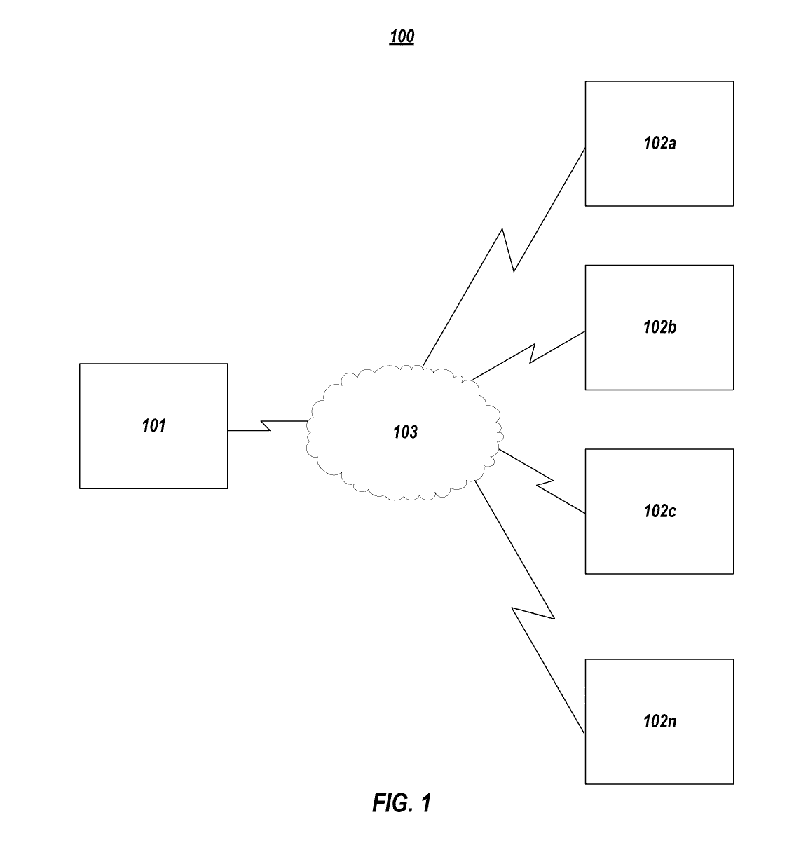

FIG. 1 illustrates an example computer environment 100 in which the present invention can be implemented. Computer environment 100 includes a server system 101 and client systems 102a-102n that are connected via network 103. Server system 101 can represent any number or type of server computing components. For example, server system 101 can be a single server computing device or may be a cloud of interconnected server computing components. Similarly, client systems 102a-102n can represent any computing device capable of communicating with server system 101. Network 103 generally represents any of the various different ways in which two computing systems can communicate. In a typical example, network 103 is the internet.

Server system 101 is configured to provide content to client systems 102a-102n. This content can be customized by client systems 102a-102n as will be described below. The customized content can then be viewed on client systems 102a-102n or distributed for viewing on other client systems.

Customizing Informational Modules that are Distributed Hierarchically

According to embodiments of the invention, server system 101 can maintain a plurality of informational modules that are used for providing training or education to a client's employees. For example, a client may be a large company having many different employees located across many offices. Server system 101 can provide an interface for hierarchically distributing relevant informational modules to the employees of the company.

Examples of informational modules that may be relevant to a health care company include a HIPAA Privacy and Security module, an OSHA Safety Including Infection Control module, a Medicare module, a Human Resources module, etc. Any type of informational module can be provided in embodiments of the present invention. Accordingly, the invention can be provided to any type of industry for providing training or educational material to employees or other personnel.

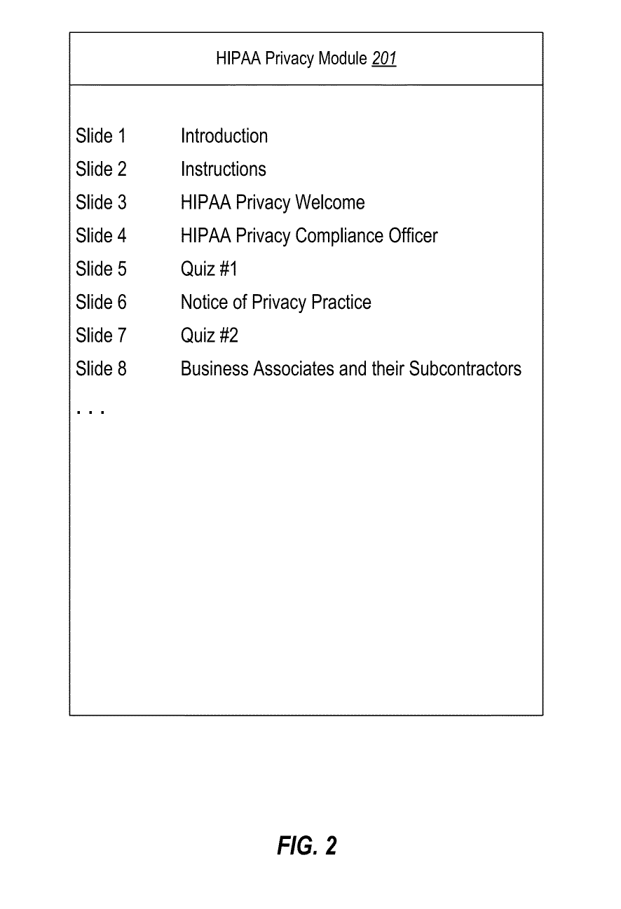

An informational module can be comprised of a plurality of units or slides. FIG. 2 illustrates an example of a plurality of slides that make up a HIPAA Privacy module 201. Each slide can contain content of different types. For example, as shown, HIPAA Privacy module 201 includes an introduction slide, various informational slides, quiz slides, etc.

When an employee views an informational module, the slides of the informational module can be displayed to the employee in a sequential manner. In this way, the content of the informational module is presented in an organized and consistent fashion to ensure that each employee that is required to receive the content can do so in an organized and easily tracked manner thereby facilitating the tracking of compliance with governing rules and regulations.

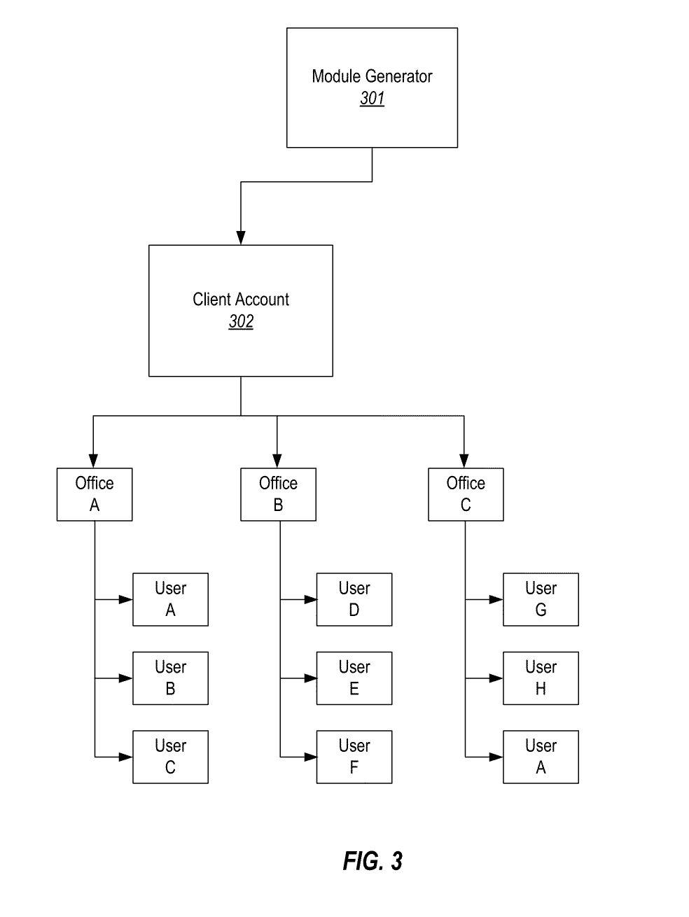

According to embodiments of the present invention, informational modules can be distributed hierarchically within an organization. FIG. 3 illustrates an example of a hierarchical structure that can be used by the present invention to distribute informational modules. A module generator 301 is at the top of the hierarchical structure. Module generator 301 creates the initial (or default) version of each informational module. Module generator 301 also maintains these initial versions of the informational modules such as by updating the content of the modules. For example, if changes are made to the HIPAA Privacy requirements, module generator 301 can be used to update the content of HIPAA Privacy module 201 to address the changes.

Once an informational module is created by module generator 301, the informational module can be provided to the other levels of the hierarchy. As shown in FIG. 3, the hierarchy can be comprised of client accounts (e.g. client account 302) which include one or more offices (e.g. offices A, B, and C). The individual users can then be grouped under the appropriate office. As shown in FIG. 3, a user can be part of more than one office (e.g. user A is under office A and office C in the hierarchy).

An office may or may not correspond to a physical office. For example, if the client is a health care organization, it may include an office in the hierarchy for each physical office in the organization. However, the organization's hierarchy may also include an office for different departments within a physical location (e.g. different departments in a hospital or clinic). Accordingly, the offices in the hierarchy should not be construed as requiring a direct association with any particular physical location. In many configurations, an office in the hierarchy may represent a logical grouping of users that are governed by similar rules or regulations.

In many embodiments, an office can represent a grouping of users whose compliance or training requirements are managed by a manager or managing entity. For example, if a medical office employs a single manager whose role is to ensure that the employees of the medical office are in compliance with governing rules and regulations, the medical office can be represented as an office (or possibly multiple offices if desired) to which the manager can have access to facilitate the administration and tracking of the employees' compliance. This administration can be facilitated by controlling how informational modules are flowed down the hierarchy to the individual users.

Similarly, a client can employ a manager or managing entity who can have access to the hierarchy at the client account level to control how the informational modules are flowed from the client account level to the individual offices under the client account. In other words, the present invention allows a client to have control over how informational modules are distributed at various levels of the client's hierarchy. This control can include determining which offices and/or users receive which informational modules and customizing the content of the information modules that the offices and/or users receive.

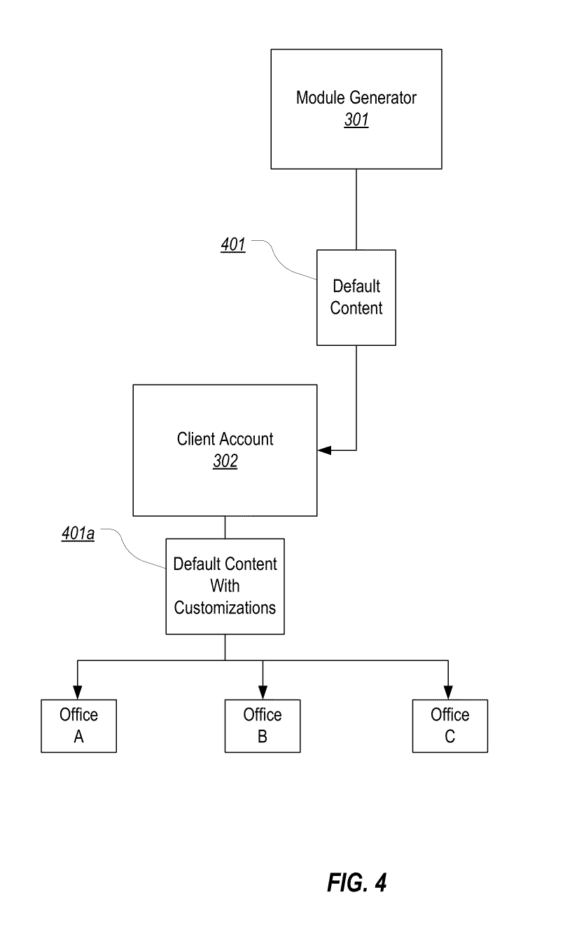

FIG. 4 illustrates an example of how a client can control the distribution of an informational module 401 at the client account 301 level. FIG. 4 shows that informational module 401, when distributed from module generator 301, contains default content. This default content can be the initial version of the informational module or may be an updated version of the informational module. In any case, informational module 401 with the default content represents the form of the information module that is provided to all client accounts in the system that are configured to receive informational module 401 (i.e. client account 302 and any other client account in the system configured to receive informational module 401 will receive informational module 401 with the same default content).

At the client account level of the hierarchy, the present invention provides the ability for the client to customize the content of informational module 401. Customizations to informational module 401 that are made at the client account 302 level apply to all offices under client account 302. In other words, the customized form of informational module 401 created at the client account 302 level will be provided to each of offices A, B, and C.

As shown in FIG. 4, a customized version 401a of informational module 401 is distributed to offices A, B, and C. Customized version 401a contains the default content with customizations. These customizations can include additions to the default content, deletions of portions of the default content, or other modifications to the default content. In this manner, a client can easily control the content that is distributed in an informational module to each of the client's offices by making the customizations at the client account level.

FIG. 4 shows that informational module 401 is distributed to each of offices A, B, and C. However, a client can also control how an informational module is distributed by specifying which offices should receive an informational module. For example, if the client determines that office C should not receive informational module 401 (e.g. because its employees are not governed by the regulations addressed in informational module 401), the client account can specify that informational module 401 should only be distributed to offices A and B.

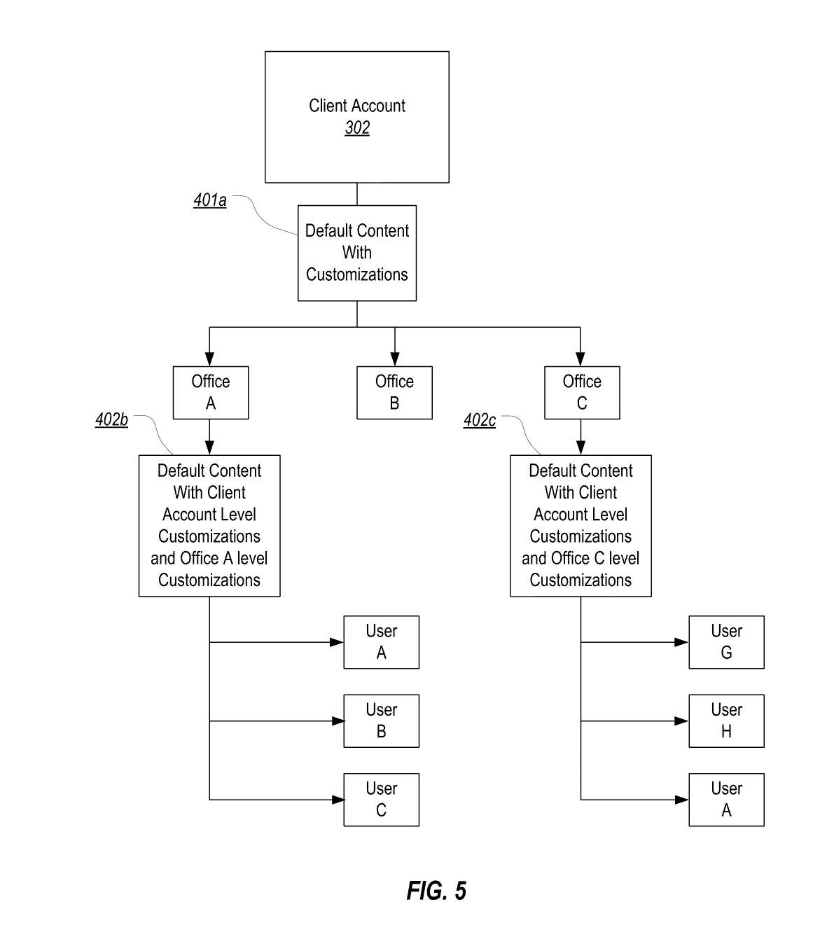

At the office level of the hierarchy, the present invention also provides the ability for the office (e.g. a compliance manager of the office) to customize the content of an informational module received from the client account level. FIG. 5 illustrates that each office can each independently customize informational module 401a. Specifically, FIG. 5 shows that office A has made customizations to informational module 401a to generate a version 402b which users A, B, and C receive, and office C has made customizations to informational module 401a to generate a version 402c which users G, H, and A will receive. In this way, a manager of each office in the hierarchy can customize an informational module for the particular users within the office.

By distributing informational modules in this manner, the present invention facilitates the administration and tracking of compliance with governing rules and regulations or other training material. For example, because the primary content of an informational module is substantially provided by module generator 301, a client can rely on module generator 301 to generate and maintain informational modules containing the most up-to-date content to ensure that each user receives the information necessary for compliance. Then, each client and/or office can customize the content of the informational module it receives to tailor the content for the offices or users that will receive the informational module.

In this way, a client can easily ensure that each of its employees receives the same custom information by adding the custom information to an informational module at the client account level. Similarly, an office can easily ensure that each employee in the office receives the same office level customizations by adding the customizations at the office level. This feature also ensures that customizations that are only applicable to some offices do not need to be distributed to each of the client's offices simply by applying the customizations at the office level as opposed to the client account level.

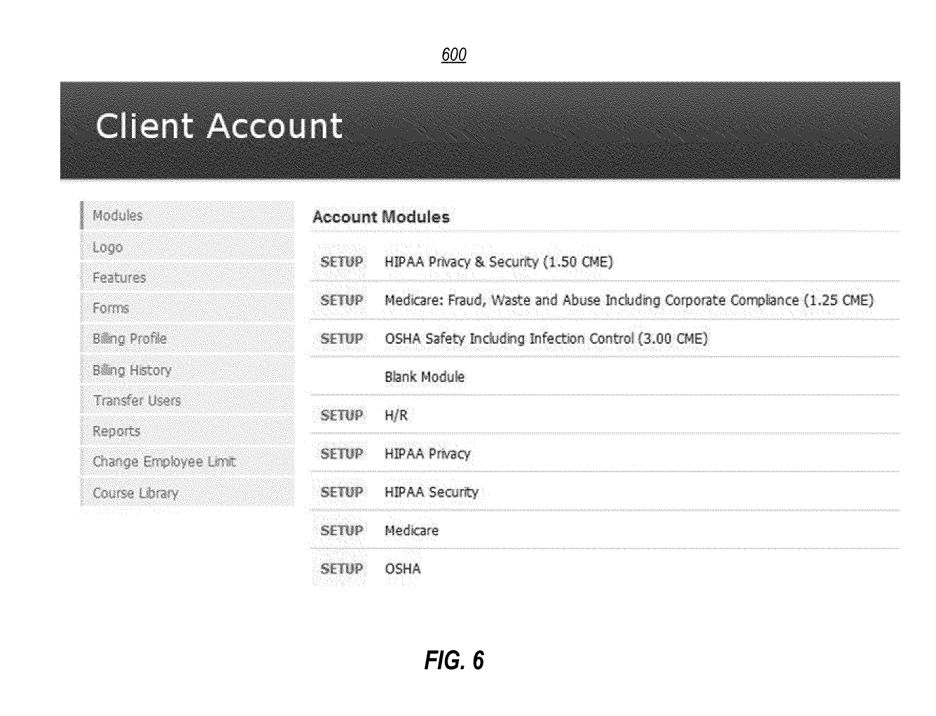

FIGS. 6-17 illustrate screenshots of an example implementation of the present invention. FIGS. 6-17 can be displayed as webpages to a user of a system configured in accordance with the present invention to allow the user to customize the content of slides of an informational module and to administer the informational module to users.

FIG. 6 illustrates a webpage 600 that can be displayed to a manager at the client account level. Webpage 600 lists the informational modules that are provided to the client account (e.g. client account 302). As shown, each of these informational modules can be customized by selecting the setup button to the left of each module.

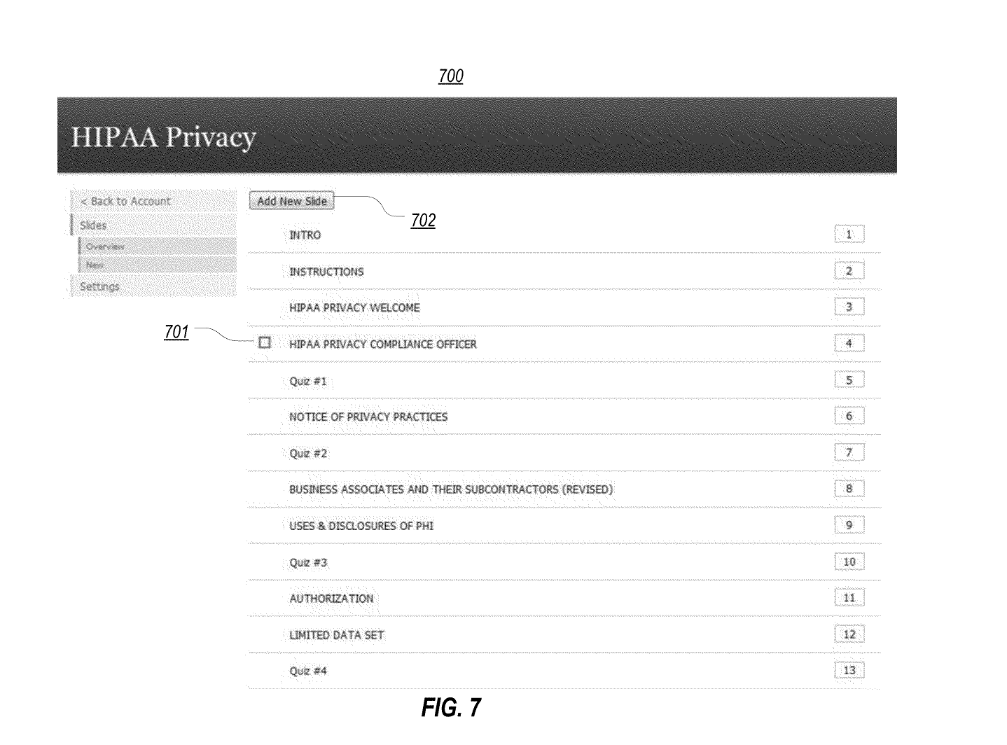

FIG. 7 illustrates a portion of a webpage 700 that can be displayed when the manager selects the setup button associated with the HIPAA Privacy module shown in webpage 600. Webpage 700 lists each of the slides that are included in the HIPAA Privacy module. By selecting any of the listed slides, custom content can be added to the content of the slide. In some cases, a slide may require the addition of custom content. Such slides can be identified by a marker 701 to inform the manager that customizations must be made to these slides before the module can be distributed. Also, a new slide with custom content can be added to the module by selecting button 702.

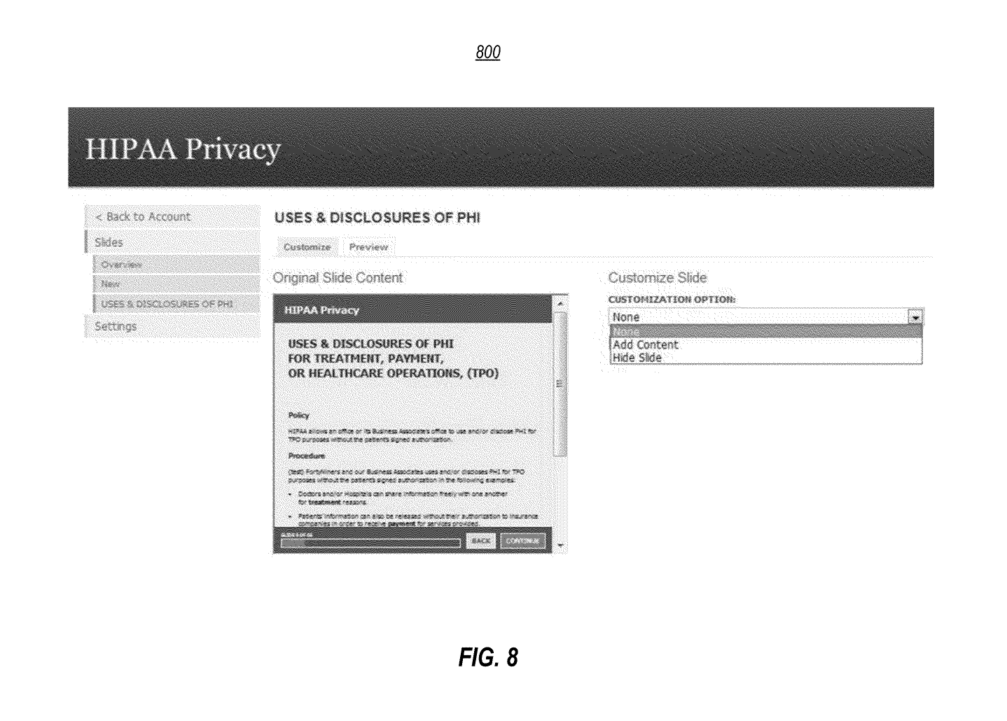

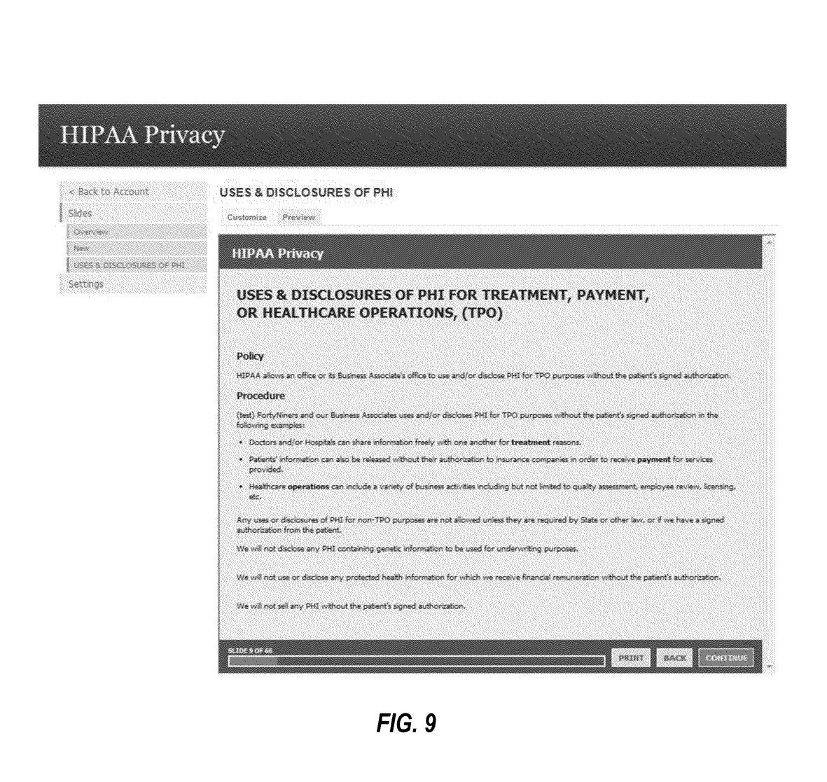

FIG. 8 illustrates a webpage 800 that can be displayed when a slide (e.g. the Uses & Disclosures of PHI slide) is selected in webpage 700. As shown, when a slide is selected, options to customize the slide are provided including adding content to the original content of the slide and hiding the slide. If the manager selects to hide the slide, users viewing the informational module will not see the hidden slide. Webpage 800 also includes an option to preview a slide. FIG. 9 illustrates an example of a preview that is displayed when the preview option is selected.

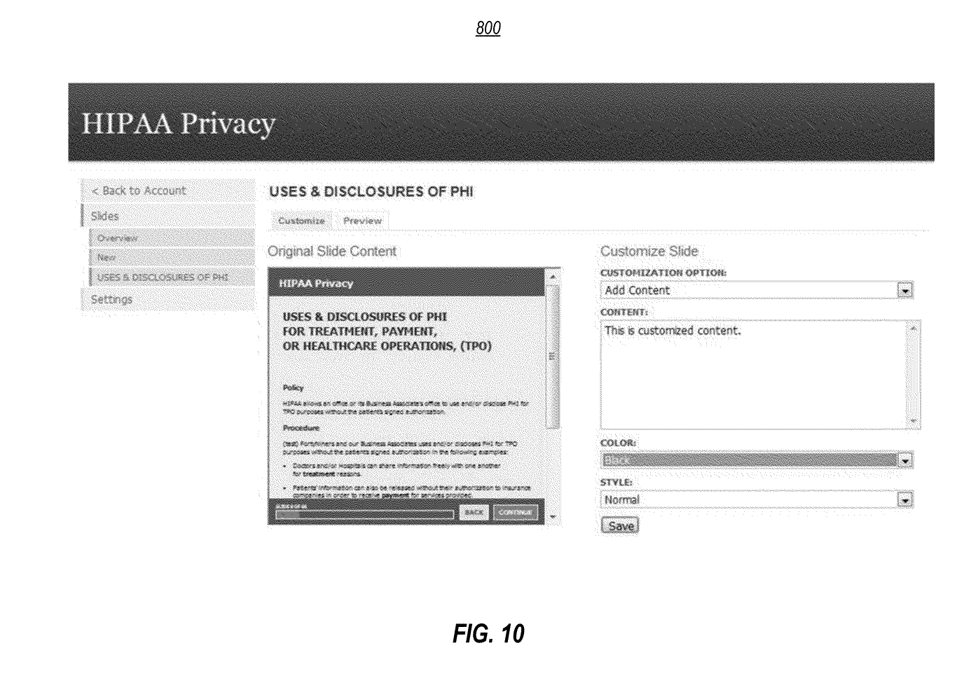

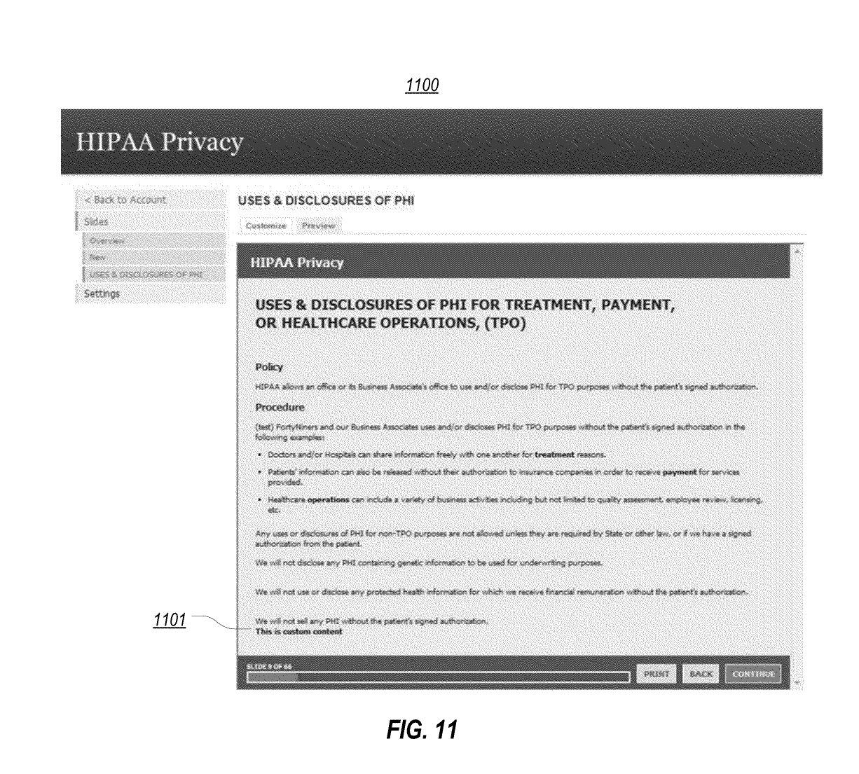

When the option to add content to the slide is selected in webpage 800, various fields for adding the custom content can be displayed as is shown in FIG. 10. In FIG. 10, the manager has added the sentence “This is customized content.” into the content field. When these customizations are saved, the sentence will be added to the original slide content. For example, as identified by 1101 in FIG. 11, the sentence has been added to the original slide content. Each user under the client account will then see this custom content when viewing the informational module.

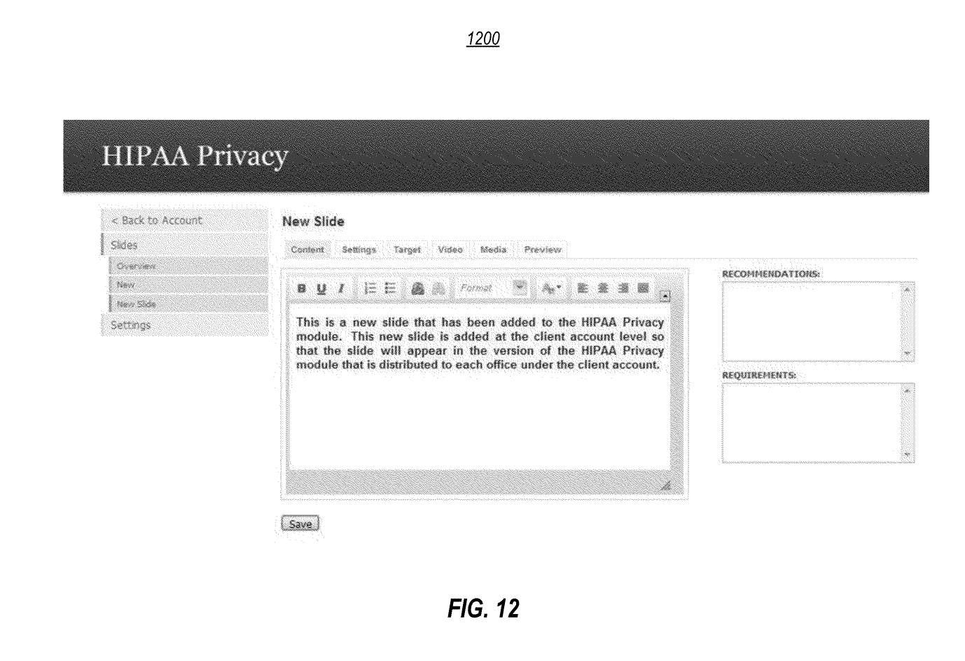

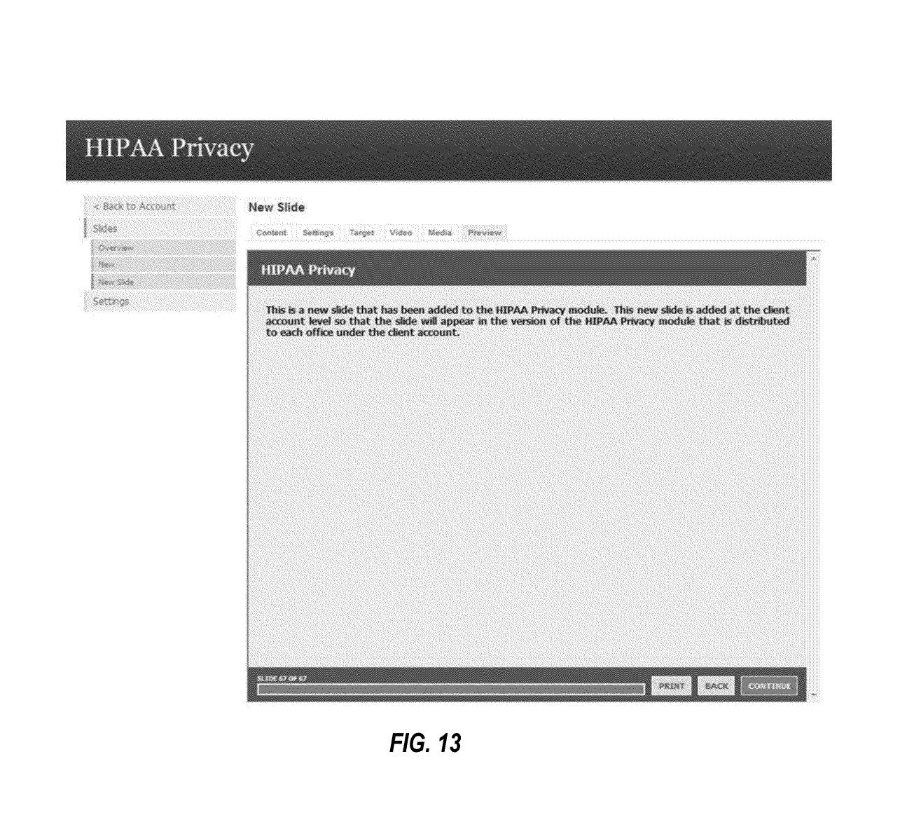

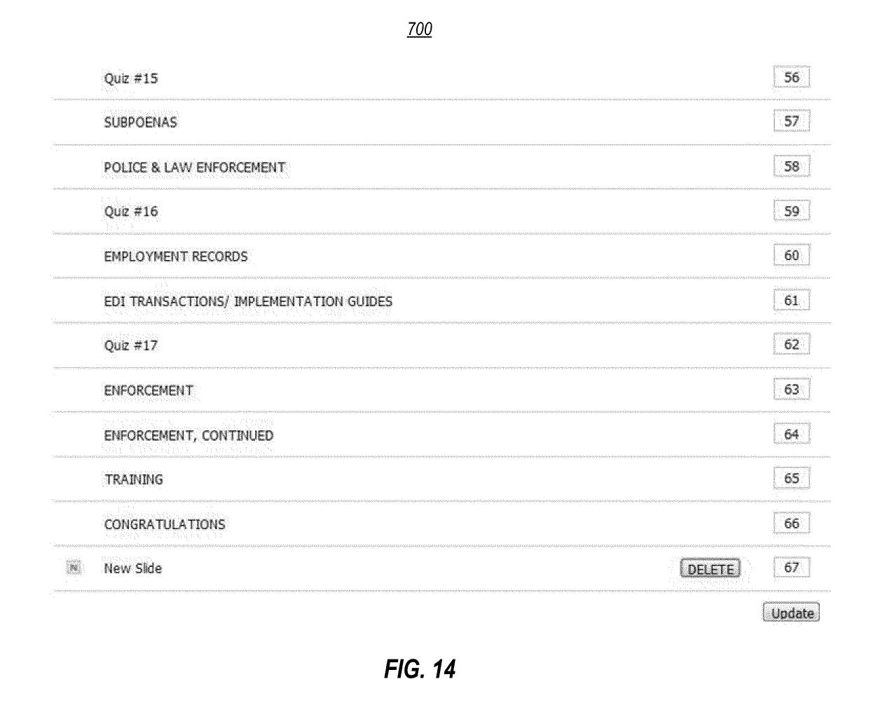

FIG. 12 illustrates a webpage 1200 that can be displayed when the manager selects button 702 to add a new slide to the informational module. Webpage 1200 includes various fields and controls for adding content to the new slide. This content can be text as shown in FIG. 12 or other content such as multimedia content. Additionally, recommendations or requirements can be attached to the new slide. For example, a requirement can include the taking of a quiz before the user can advance past the slide. Accordingly, a manager can create new slides having many different types of content. FIG. 13 illustrates a preview of the new slide as it will appear to the user when the user views the informational module. FIG. 14 illustrates another portion of webpage 700 and show that the new slide has been added as slide 67 of the HIPAA Privacy module. Because the new slide is added at the client account level, the new slide will appear in the version of the HIPAA Privacy module that is distributed to each office and each user under the client account (unless a customization is made at the office level which overwrites the client account level customization as will be further described below).

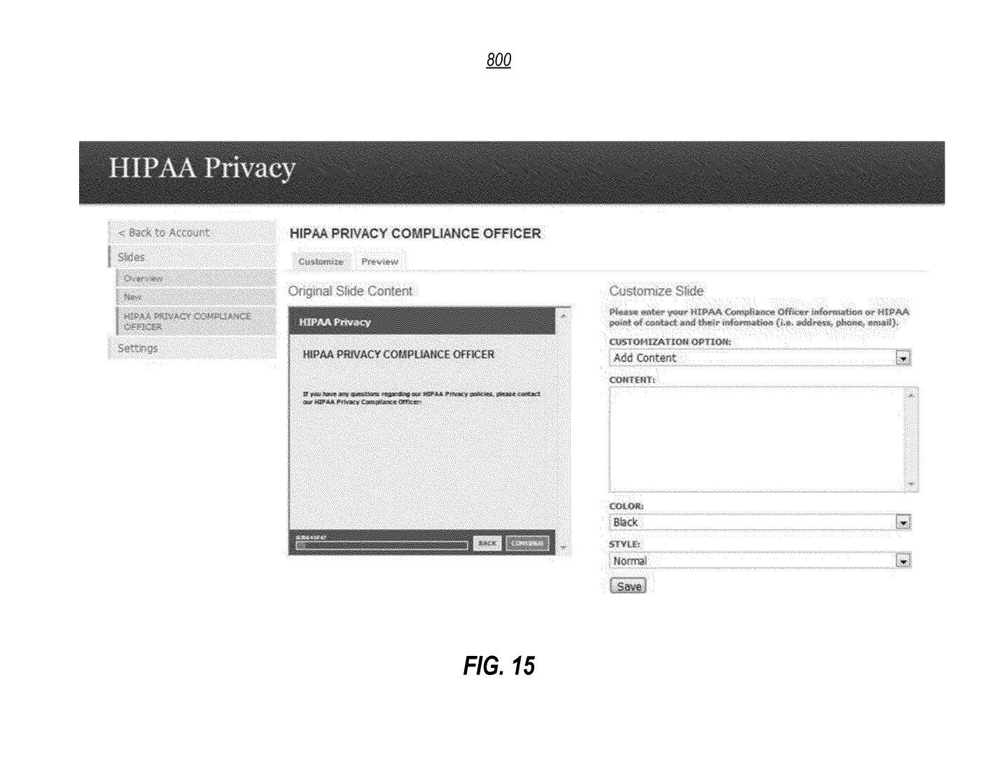

FIG. 15 illustrates webpage 800 when the slide that is selected for editing is one that requires a customization to be made. For example, webpage 800 as shown in FIG. 15 can be displayed when the HIPAA Privacy Compliance Officer slide (which is identified with marker 701) is selected within webpage 700. In contrast to FIG. 10, FIG. 15 includes instructions requesting that the manager enter the client's HIPAA Compliance Officer and contact information. Once entered, this information will be included in the slide in the same manner as described above.

Marker 701 can be added to a slide by module generator 301 to identify that custom information is required (e.g. in the case that the information needs to be added on a client-wide basis), or can be added by a manager at the client account level (e.g. in the case that the information to be added is office specific). In other words, markers can serve as an easy way to mark portions of an informational module that require additional information from a lower level of the hierarchy.

In some embodiments, markers can be used to identify slides where additional content is recommended but is not required. For example, in some embodiments, a marker for required content and a marker for recommended content can be different colors or shapes to allow the manager to quickly identify such slides. Also, in some embodiments, once the required or recommended information is added to a slide, the corresponding marker can be updated to indicate that the information has been provided. Further, in some embodiments, where a slide has been hidden, a marker can be provided to indicate that the slide is hidden. In this way, a manager can see all slides that are part of an informational module while also quickly identifying which slides are hidden from the users when the module is viewed.

The above description of FIGS. 6-15 have described the customizations as being applied at the client account level. However, customizations can be made at the office level in a similar manner. For example, when a manager at the office level accesses the system of the present invention, he may see a webpage similar to webpage 600 that lists each module that is provided to the office. The manager can then select to customize any of the listed modules by adding content to slides, hiding slides, or adding new slides as described above. These customizations can include customizations to content that was added by a customization made at the client account level.

Such customizations made at the office level will be included in the version of the informational module that is distributed to users under the office in the hierarchy, but will not appear in other versions of the informational module that are distributed to users under other offices. In this way, customizations can easily be made specifically for employees of a particular office without affecting the content of an informational module provided to employees of another office.

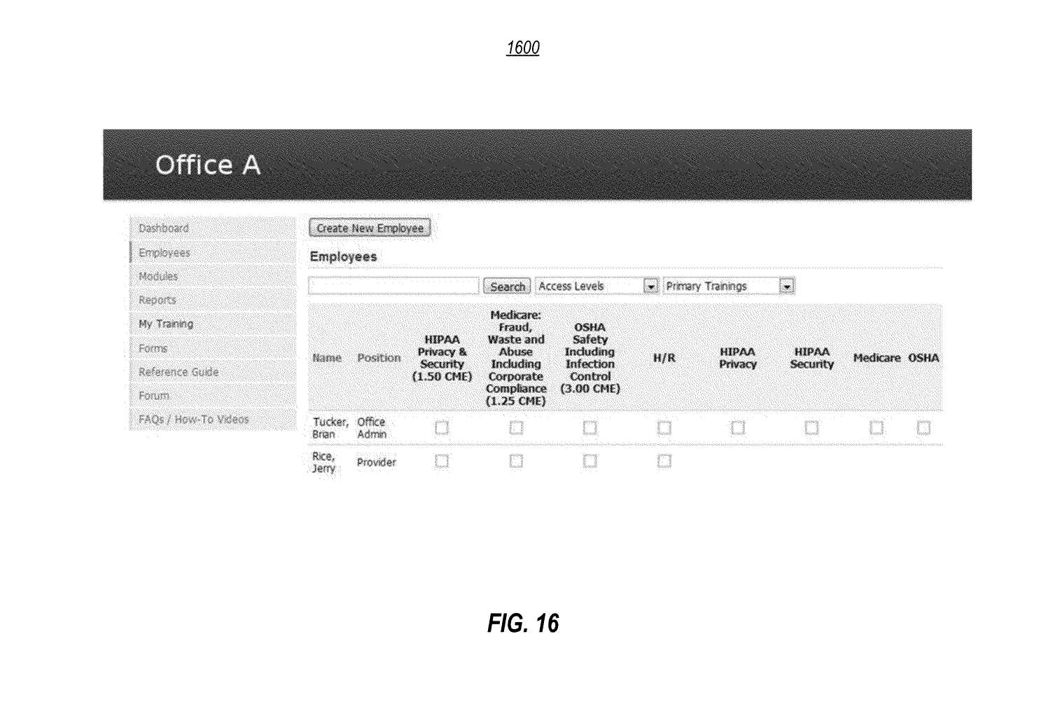

In addition to the customizations that can be made to a module at the client account and office levels, the present invention also allows a manager at the office level to specify which employees receive which modules. FIG. 16 illustrates a webpage 1600 that lists (in rows) two employees of office A. Webpage 600 also lists (in columns) each informational module available to office A. The boxes indicate which of these modules are assigned to each employee. For example, the first employee is assigned each of the informational modules available to office A (which may be because the first employee as the office administrator is governed by the rules and regulations addressed in each informational module). In contrast, the second employee only has access to the first four informational modules (which may be because the second employee as a provider is only governed by the rules and regulations of the first four informational modules).

Each employee can be associated with an access level (e.g. office administrator or provider) which, in some embodiments, defines which informational modules are assigned to the employee. In some embodiments, custom access levels can be created by a manager in the system (e.g. a manager at the office, client account, or module generator level). For example, if a manager at the office level determines that a certain group of employees should only have access to (or be assigned) a subset of the informational modules and that an access group does not exist that provides access only to the subset, the manager can create a new access level (or request creation of the new access level) that defines the subset. Each employee in the group can then be associated with the new access level to thereby provide each of these employees with access to the subset. By using access levels, the manager can be relieved from having to individually assign modules to each user.

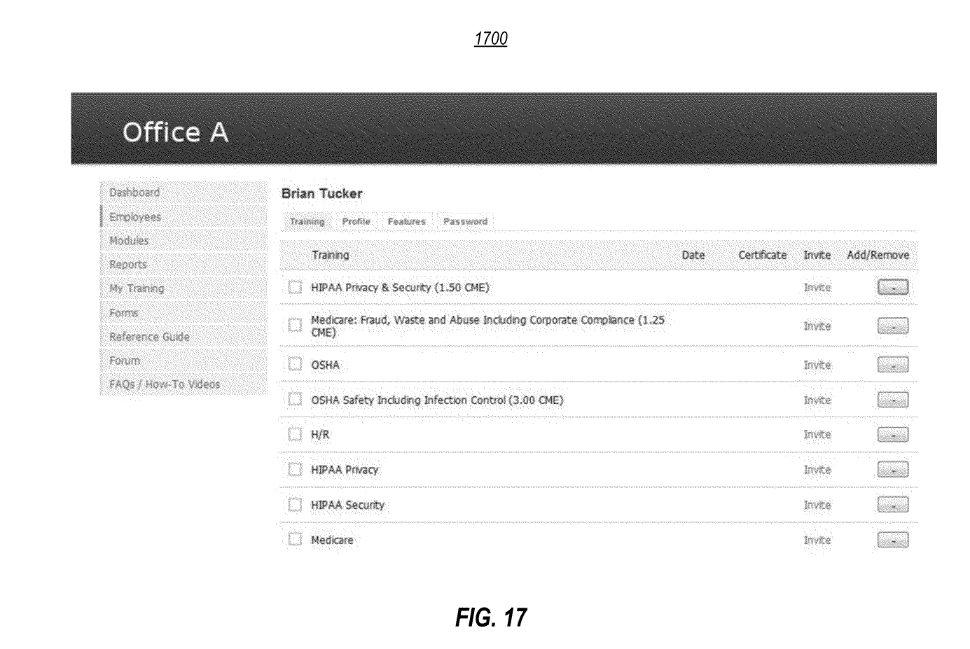

In some embodiments, it may be desirable to individually provide a user with access to an informational module (as opposed to assigning modules using an access level), or to customize which informational modules a user has access to after the user has been assigned an access level. FIG. 17 illustrates a webpage 1700 where these customizations can be made. Webpage 1700 can be displayed when an employee is selected within webpage 1600.

As shown in FIG. 17, the employee has access to each module provided to Office A. However, webpage 1700 allows access to any of the modules to be removed by selecting the Add/Remove button associated with the module. In this way, the modules that a user has access to can be individually customized.

FIG. 17 also shows that webpage 1700 includes an option to send an invite to a user to review a corresponding informational module. A user can be invited to review an informational module when the user is required to comply with a rule or regulation described in the informational module. Similarly, a user can be invited to review an informational module when a manager believes it would be helpful to the user. The invite can be in the form of an email or other electronic communication that informs the user that he should view the informational module and perform any tasks required to comply with the associated rules or regulations discussed in the module. In this way, a compliance manager of an office can quickly invite employees of the office to take the necessary steps to reach compliance.

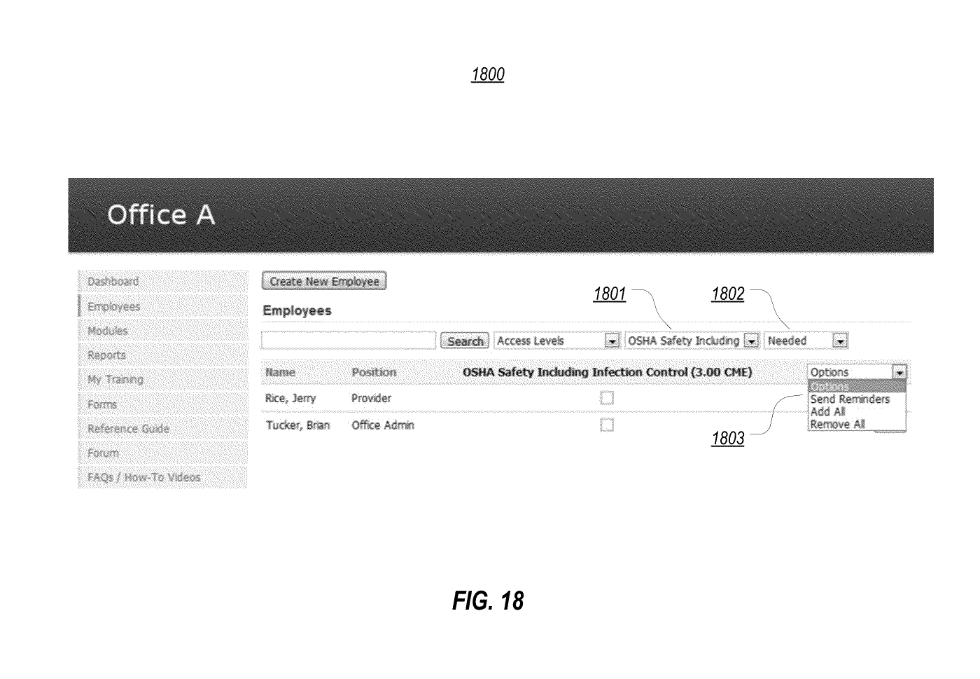

In some embodiments, the present invention can provide options for quickly identifying all users that have yet to review an informational module to which they are assigned, and for sending out an invite or reminder to these users to review the informational module. FIG. 18 illustrates webpage 1600 when a particular informational module is selected from drop down list 1801. In this case, the OSHA Safety Including Infection Control module has been selected. When this module is selected in drop down list 1801, webpage 1600 can initially display all users in the office with an indication of which users the module has been assigned to (e.g. by displaying a box next to the user's name).

Drop down list 1802 can include other options for filtering the view of the employees. For example, when an Assigned option is selected, only the users to which the module is assigned will be displayed. When a Needed option is selected as shown in FIG. 18, users to whom the module has been assigned but that have not reviewed or completed the module are shown. When a Completed option is selected, any users that are assigned the module and have completed the module are shown.

As shown in FIG. 18, once an option is selected in drop down list 1802, a drop down list 1803 can be displayed to provide options with regards to the users that are currently listed as matching the criteria in drop down list 1801 (and the other drop down lists). As shown, drop down list 1803 includes a Send Reminders option which can be selected to send a reminder (or invite) to each listed user to complete the module. In cases where the listed users include users to which the module is not assigned, the selection of the Send Reminders option can cause a reminder to be sent only to those users to whom the module is assigned.

In some embodiments, reminders can be sent out automatically. For example, when a user has been assigned a module, a reminder to complete the module can be sent to the user at a specified frequency until the user has completed the module. In some embodiments, the frequency at which reminders are sent can be customizable at the individual user level. Alternatively, the frequency of reminders can be customizable for a particular access level or other grouping of users.

Further, in some embodiments, the type of reminder can be customizable for a particular user or an access level or other grouping. For example, reminders sent to users that have an access level of provider can be sent as text messages while reminders sent to users that have an access level of employee can be sent as email messages. Similar customizations can be made to the actual contents of the reminders. For example, the content of a reminder to an employee can be different than the content of a reminder to a provider.

In cases where some or all of the listed users are not assigned the module, the Add All option can be selected to cause the module to be assigned to all listed users. In FIG. 18, because each listed user is already assigned the module, selecting the Add All option will have no effect. Similarly, when the Remove All option is selected, the assignment of the module to each listed user will be removed. In FIG. 18, selection of the Remove All option will result in the OSHA Safety module being unassigned from both users.

As can be seen, webpage 1600 provides a succinct and simple interface for managing the assignment of modules within an office and for tracking completion of assigned modules. From a single user interface, the manager can identify who is assigned a module and who has completed a module, and can generate reminders for those who have not completed the module.

In some embodiments of the present invention, additional customizations of informational modules can be made for a particular access level. For example, as described above, an informational module can be customized at the client account level resulting in each office under the client account receiving the custom content, and at the office level resulting in each user of the office receiving the custom content. In some embodiments, customizations at these two levels can be restricted to a particular access level.

For example, if it is desired to add custom content to a slide of an informational module and distribute the custom content only to users having an access level of Nurse, the version of the informational module with the custom content can be associated with each user having an access level of nurse (whether within a single office or across offices). In this way, when a user that has an access level of nurse accesses the informational module, the version of the informational module that the nurse will see contains the custom content while a user having another access level will not see the custom content.

In some embodiments, when a customization is restricted to a particular access level, the customization will be applied to users matching the access level within a single office if the customization is made at the office level (e.g. by an office manager) whereas, if the customization is made at the client account level, the customization will be applied to users matching the access level in each office under the client account. For example, if a manager of the client account adds custom content to an informational module and indicates that the custom content is to be associated with all users having an access level of Human Resources, the custom content will be included in the version of the informational module provided to all users in any office that have an access level of Human Resources.

Accordingly, the present invention also allows customizations to informational modules to be targeted towards individual users based on an access level of the user. An access level should be construed to include any grouping of users based on any number of criteria. For example, an access level may be defined for engineers, accountants, administrators, human resources professionals, attorneys, secretaries, or any other type of grouping desired.

To summarize, the present invention can allow customizations to be made to the content of an informational module at two general levels: the client account level and the office level. Customizations made to the content of the informational module at the client account level will appear in the versions of the informational modules that are distributed to the offices and ultimately to the users. Customizations that are made at the office level will appear in the version of the informational modules that are distributed to the users of the office making the customizations. Customizations that are targeted to a particular access level or grouping will appear in the version of the informational modules that are distributed to the users having the associated grouping or access level.

In cases where a customization made at the client account level may conflict with a customization made at the office level, it may be determined which customization should appear in the informational module. For example, a slide may require a customization that adds the name and contact information for an officer that should be contacted to report a violation of a rule or regulation. A manager at the client account level may customize the slide by supplying a name and contact information for inclusion in the slide. Then, a manager at the office level may customize the same slide by providing a different name and contact information. The present invention may determine that the name and contact provided by the manager at the office level is the appropriate customization and include that name and contact information in place of those provided by the manager at the client account level.

In some embodiments, some customizations provided at the client account level can be viewed as default data for a particular slide that can be (or should be) overwritten by customizations provided at the office level. Likewise, some customizations provided at the client account level can be locked to prevent the customizations from being modified at the office level.

In some embodiments, where multiple slides or multiple locations within a slide require the same customizations, the present invention can provide functionality for receiving the customizations one time and populating each slide or location with the customization. For example, referring to FIGS. 7 and 15, the HIPAA Privacy and Compliance Officer slide requires the input of the compliance officer's name and contact information. In some cases, the compliance officer's name and contact information may also be required in one or more other slides in the informational module or another informational module. In such cases, the present invention can receive the input of the compliance officer's name and contact information (e.g. via the fields shown in FIG. 15) and automatically input the name and contact information in each slide that requires it. In this way, the manager needs only input the information one time.

In some embodiments, customizations that are auto-populated in this manner can be stored as default content that can be overwritten at the office level by providing other customizations (e.g. a different name and contact information for an office specific compliance officer). Such slides that contain default content can be identified accordingly to assist the manager at the office level in identifying where customizations to default data may be desirable or required. Any customization applied to the default data at the office level can also be auto-populated to overwrite each instance where the default data was added at the client account level.

This auto-population of customizations can also occur in different media types. For example, in addition to providing informational modules, the present invention can also provide manuals or other reference materials that can be accessed by users. These manuals may provide similar information as the informational modules. Accordingly, where necessary, the present invention can auto-populate locations in the manual or other reference materials with customizations. Alternatively, a customization can be made to the manual or other reference and then the customization can be auto-populated into one or more slides.

In some embodiments, the present invention can provide a separate tool (e.g. a wizard) for receiving customizations that should be auto-populated in different slides of an informational module or in different locations of a manual or other reference material. By providing a separate tool, a manager at either the client account of office level can quickly provide customizations in a single tool or interface without having to scroll through the slides of each informational module to identify where the customizations may be required.

The above description has primarily described examples where the present invention is used to administer and track a compliance program in a health related organization. However, the present invention can be used to administer and track a compliance program in virtually any industry such as the industrial or chemical industries, the tax or accounting industries, the legal industry, the food services industry, etc. Similarly, the present invention can be used to administer and track a training program where there may not be any compliance regulations. For example, an employer may distribute informational modules to its employees to train them regarding a particular topic. However, the present invention is particularly beneficial in administering compliance because it allows the common content required for compliance to be provided and updated at the module generator level thereby relieving the client from the burden of tracking changes in governing regulations and updating content to comply with such changes.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method, performed by a server computing system, for providing customizations to an informational module that is distributed hierarchically from a client account to one or more offices and to one or more users in the one or more offices, the method comprising:
generating, by the server computing system, an informational module containing default content, the default content corresponding to one or more rules or regulations governing an industry;
distributing the informational module to a client account of a first client, the client account having one or more offices arranged hierarchically below the client account, each of the one or more offices having one or more users arranged hierarchically below the office;
receiving, from the client account, a customization to the default content of the informational module;
updating the informational module to include the default content and the customization to the default content; and
distributing the informational module to each of the one or more offices arranged hierarchically below the client account such that the informational module with the customization to the default content is made available to at least one user in each of the one or more offices.

2. The method of claim 1, wherein the customization comprises one of an addition to the default content or removal of a portion of the default content.

3. The method of claim 1, wherein the informational module is arranged into a plurality of slides that each include default content.

4. The method of claim 3, wherein the customization comprises one of adding a slide to the informational module or hiding a slide of the informational module.

5. The method of claim 3, wherein at least one of the slides includes a marker that identifies that the slide requires additional content, and wherein the customization comprises adding the additional content to the at least one slide.

6. The method of claim 2, wherein the customization comprises adding content to a first portion of the informational module, the method further comprising:
identifying that one or more other portions of the informational module require the same content that was added to the first portion; and
automatically adding the same content to the one or more other portions such that the client account does not need to manually add the same content to the one or more other portions.

7. The method of claim 6, further comprising:
identifying that one or more other reference materials require the same content that was added to the first portion of the informational module; and
automatically adding the same content to the one or more other reference materials.

8. The method of claim 1, further comprising:
receiving, from a first office of the one or more offices arranged hierarchically below the client account, a customization to the content of the informational module;
updating the informational module to include the customization to the content of the informational module; and
distributing the informational module with the customization received from the first office to at least one user in the first office.

9. The method of claim 8, wherein the customization to the content of the informational module comprises one or more of:
adding content to the informational module;
replacing at least a portion of the customization that was received from the client account; or
hiding one or more portions of the informational module.

10. The method of claim 1, further comprising:
receiving, from a first office of the one or more offices arranged hierarchically below the client account, a request to assign the informational module to a user in the first office; and
assigning the informational module to the user such that the user can access the informational module that contains the customization received from the client account.

11. The method of claim 1, further comprising:
providing, to a first office of the one or more offices arranged hierarchically below the client account, a user interface that contains one or more of:
an option to view each user in the first office to which the informational module is assigned;
an option to view each user in the first office that has completed the informational module;
an option to send a reminder to each user in the first office to whom the informational module is assigned but who has not completed the informational module, the reminder informing each user to complete the informational module;
an option to assign the informational module to each user in the first office; or
an option to un-assign the informational module from each user in first office.

12. The method of claim 1, further comprising:
providing, to a first office of the one or more offices arranged hierarchically below the client account, a user interface that lists a user in the first office along with each informational module available to the first office, the user interface including, for each informational module, an option to assign or un-assign the informational module to the user and an option to send an invitation to the user to access the informational module.

13. The method of claim 1, further comprising:
receiving, from the client account or from one of the one or more offices arranged hierarchically below the client account, a customization to the content of the informational module, the customization including an indication that the customization is to be applied to a version of the informational module that is to be provided to a grouping of users;
generating a version of the informational module that contains the customization; and
providing the version of the informational module only to users in the grouping.

14. The method of claim 13, wherein the customization is received from the client account and wherein providing the version of the informational module only to users in the grouping comprises providing the version of the informational module to any user in any of the one or more offices that is in the grouping.

15. The method of claim 13, wherein the customization is received from a first office and wherein providing the version of the informational module only to users in the grouping comprises providing the version of the informational module to any user in the first office that is in the grouping.

16. The method of claim 1, further comprising:
updating the default content of the informational module; and
distributing the informational module with the updated default content and the customization received from the client account to each of the one or more offices.

17. A method, performed by a server computing system, for providing customizations to an informational module that is distributed hierarchically from a client account to one or more offices and to one or more users in the one or more offices, the method comprising:
generating, by the server computing system, an informational module containing content corresponding to one or more rules or regulations governing an industry;
distributing the informational module to a client account of a first client, the client account having one or more offices arranged hierarchically below the client account, each of the one or more offices having one or more users arranged hierarchically below the office;
distributing the informational module to a first office of the one or more offices;
receiving, from the first office, a customization to the content of the informational module;
updating the informational module to include the customization to the content; and
distributing the informational module with the customization to at least one user in the first office.

18. The method of claim 17, wherein the customization comprises one or more of:
adding content to the informational module;
replacing at least a portion of the content of the informational module; or
hiding one or more portions of the informational module.

19. The method of claim 17, further comprising:
receiving, from the client account, a customization to the content of the informational module; and
updating the informational module to include the customization received from the client account such that informational module distributed to the at least one user in the first office includes the customization received from the client account as well as the customization received from the first office.

20. The method of claim 19, wherein the customization received from the first office at least partially replaces the customization received from the client account.

21. The method of claim 17, further comprising:
updating, by the server system, the content of the informational module; and
distributing the informational module with the updated content and the customization received from the first office to the first office.

22. The method of claim 21, further comprising:
distributing the informational module with the updated content but without the customization received from the first office to one or more other offices.

23. The method of claim 17, wherein the customization to the content of the informational module comprises adding content to the informational module, the method further comprising:
identifying that the added content is required to be added in one or more other parts of the informational module; and
automatically adding the content to the one or more other parts.

24. The method of claim 17, wherein the customization includes an identification that the customization is only applicable to a grouping of users in the first office, and wherein distributing the informational module with the customization to at least one user in the first office comprises distributing the informational module with the customization only to users in the grouping.

25. The method of claim 19, wherein the customization received from the client account includes an identification that the customization is only applicable to a grouping of users, and wherein distributing the informational module with the customization received from the client account and the customization received from the first office to at least one user in the first office comprises distributing the informational module with the customizations received from the client account and the first office only to users in the grouping.

26. The method of claim 25, further comprising:
distributing the informational module with the customization received from the client account only to users in one or more other offices that are in the grouping.

27. A method, performed by a server computing system, for facilitating the tracking of compliance with one or more rules or regulations governing an industry, the method comprising:
generating, by the server computing system, an informational module containing content corresponding to one or more rules or regulations governing an industry;
distributing the informational module to a client account of a first client, the client account having one or more offices arranged hierarchically below the client account, each of the one or more offices having one or more users arranged hierarchically below the office;
distributing the informational module to a first office of the one or more offices;
receiving, from the first office, input that assigns the informational module to a plurality of users in the first office;
providing a first user interface to each of the plurality of users by which the users can access the informational module to complete the informational module;
tracking which of the plurality of clients has completed the informational module; and
providing a second user interface to the first office, the second interface comprising a listing of the plurality of users and including an indication of whether each of the plurality of users has completed the informational module.

28. The method of claim 27, wherein the second user interface includes an option to view each user in the first office to which the informational module is assigned.

29. The method of claim 27, wherein the second user interface includes an option to view each user in the first office that has completed the informational module.

30. The method of claim 27, wherein the second user interface includes an option to send a reminder to each user in the first office to whom the informational module is assigned but who has not completed the informational module, the reminder informing each user to complete the informational module.

31. The method of claim 27, wherein the second user interface includes an option to assign the informational module to each user in the first office.

32. The method of claim 27, wherein the second user interface includes an option to un-assign the informational module from one or more users in the first office.
